(19) United States
(12) Patent Application Publication
(10) Pub. No.: US 2004/0078650 A1
(43) Pub. Date: Apr. 22, 2004

(54) Method and apparatus for testing errors in microprocessors

(76) Inventors: Kevin David Safford, Fort Collins, CO (US); Jeremy P. Petsinger, Fort Collins, CO (US); Karl P. Brummel, Chicago, IL (US)

Correspondence Address: HEWLETT-PACKARD COMPANY, Intellectual Property Administration, P.O. Box 272400, Fort Collins, CO, 80527-2400, US

(21) Appl. No.: 10/183,560

(22) Filed: Jun. 28, 2002

(51) Int. Cl. G06F 11/00

(52) U.S. Cl. 714/11

(57) ABSTRACT

In an advanced multi-core processor architecture, an apparatus and corresponding method, are used to test lock step performance. The apparatus is implemented on two or more processors operating in a lock step mode. Each of the processors includes processor logic to execute a code sequence, and an identical code sequence is executed by the processor logic of each of the two or more processors. A processor-specific resource is referenced by the code sequence, and a state machine asserts a signal based on the occurrence of a programmable event. The apparatus includes an output to provide the asserted signal; and a lock step logic block operates to read and compare the output of each of the more processors. The apparatus may be used to repeatedly and deterministically provide errors that may lead to a loss of lock step.

### TECHNICAL FIELD

The technical field is testing for errors in computer systems employing lock stepped processors.

### BACKGROUND

Silicon devices, including microprocessors in a computer system, are increasingly susceptible to “soft errors,” such as errors that are produced by cosmic rays or alpha particles. Impingement of cosmic rays and alpha particles can cause a node within a microprocessor to change state, thereby introducing a “soft error.” Soft errors are transient, and may not be visible to other parts of the computer system. Many computer systems, and microprocessors specifically, include hardware to detect and correct the soft errors, in order to improve reliability. Prior art microprocessors include the ability to initialize error (parity) bits within various arrays in the microprocessor in order to test the microprocessor's error detection/error correction hardware.

To further enhance computer system reliability, a technique called lock stepped cores, or Functional Reliability Check (FRC) is used in which two or more microprocessors, or microprocessor cores operate in a master/checker pair, with outputs of the two or more cores continually compared. Any differences in the outputs indicates an error condition, including possibly a soft error condition. However, because soft errors are transient, hardware used to detect and correct the soft errors is difficult to verify in silicon.

### SUMMARY

In an advanced multi-core processor architecture, an apparatus, and corresponding method, are used to test operation of lock step processors. In an embodiment, the apparatus comprises two or more processors operating in a lock step mode, wherein each of the two or more processors includes processor logic to execute a code sequence, wherein an identical code sequence is executed by the processor logic of each of the two or more processors, a processor-specific resource referenced by the code sequence, a state machine that asserts a signal based on the occurrence of a programmable event, and an output to provide the asserted signal; and a lock step logic block operable to read and compare the output of each of the two or more processors. The processor outputs, based on execution of the code sequence, are provided to the lock step logic operable to read and compare the output of each of the two or more processors.

### DESCRIPTION OF THE DRAWINGS

The detailed description will refer to the following figures, in which like numbers refer to like elements, and in which:

FIG. 1 is a logical diagram of a silicon debug environment showing an apparatus to allow deterministic occurrence of events in order to verify proper operation of microprocessors, including lock stepped microprocessors;

FIGS. 2A-2C illustrate user-programmable devices that may be used in the environment of FIG. 1 to assert machine checks and other errors; and

FIG. 3 is a flow chart of an operation of the apparatus of FIG. 1.

### DETAILED DESCRIPTION

An apparatus, and a corresponding method, for testing lock step functionality during a chip design process are disclosed. Lock step processors, by definition, run identical code streams, and produce identical outputs. Lock step logic incorporated into the processors, or otherwise associated with the processors, is used to detect a difference in outputs of the lock step processors. A difference in outputs is indicative of an error condition in at least one of the processors, and may lead to a loss of lock step. Without direct access to the individual processors (by way of a test port, for example) a chip designer (or test writer) will not be able to insert differences (e.g., error conditions) into one or more of the lock step processors to generate the loss of lock step for testing. To test various mechanisms of the lock step logic, the apparatus and method described herein may be used to initiate errors that will be detected by the lock step logic.

As part of the testing process to verify proper lock step functionality, the chip designer will also test a lock step recovery process, that is, the process by which two or more processors that have lost lock step are restored to a lock step operating mode. The apparatus and corresponding method disclosed are designed to test this specific aspect of lock step functionality. Moreover, the apparatus and method allow for repeatability of test results.

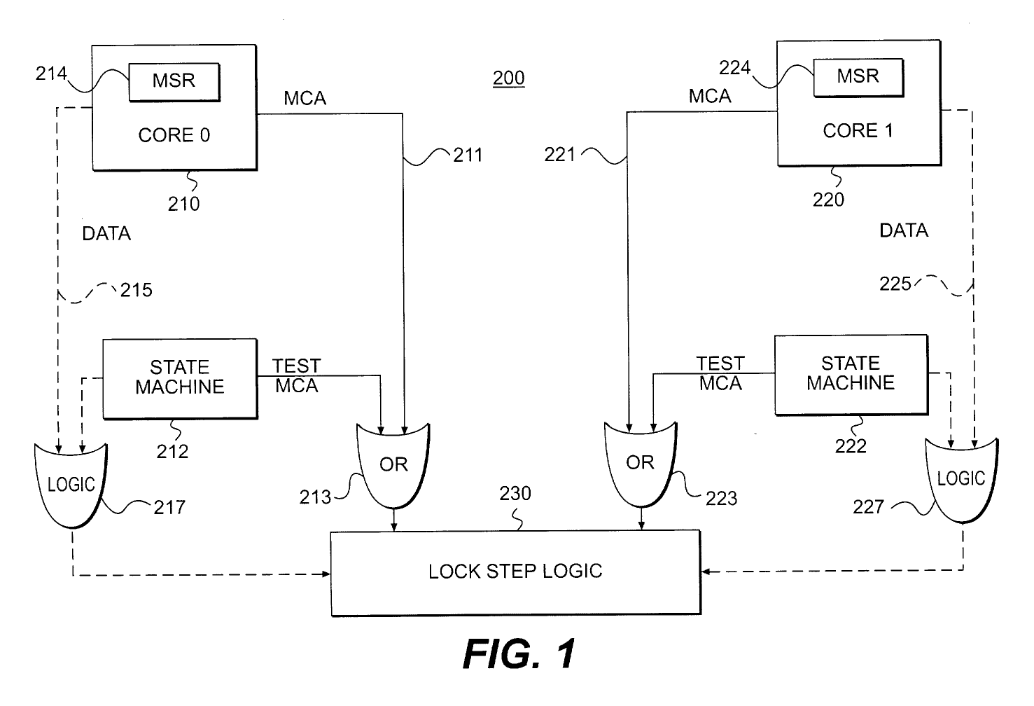

FIG. 1 illustrates a silicon debug environment 200 that allows injection of errors, and testing of lock step functions, including the ability to inject lock step errors and to test for proper recovery from a loss of lock step. In FIG. 1, a processor core 210 is coupled through error signaling path 211 and OR gate 213 to a lock step logic block 230. The processor core 210 is also coupled through data path 215 and logic element 217, which may be an OR gate, an XOR gate, a multiplexer or some other logic element, to the lock step logic 230. A processor core 220, operating in lock step with the processor core 210 is also coupled to the lock step logic block 230, using error signaling path 221 and OR gate 223, and data path 225 and logic element 227. Also coupled to the OR gate 213 is state machine 212, and coupled to the OR gate 223 is state machine 222.

The processor core 210 may comprise a processor-unique resource, such as a read-only machine specific register (MSR) 214. The MSR 214 may comprise data that are unique to the processor core 210, such as an address (core_id) of the processor core 210. Similarly, the processor core 220 may include MSR 224, which performs the same functions as the MSR 214. The error signaling paths 211 and 221, and the hardware thereon (the OR gates 213 and 223 and the state machines 212 and 222), are used to inject errors, including assertion of a test machine check (MCA) signal, or changing a bit on one of the data paths 211 and 221.

The state machines 212 and 222 may be programmable, and may be a timer/counter, an array of programmable registers, or other suitable hardware device (not shown in FIG. 1). The state machines 212 and 222 may operate according to a set number of cycles, wherein a value is decremented for each operating cycle until the value reaches zero, or other programmable value, at which point the test MCA signal is injected. Using the hardware (OR gates, data paths, and state machines), the chip designer can cause a repeatable event to occur deterministically, thereby allowing verification of the processor cores in a silicon debug environment. The processor cores 210 and 220, and the associated hardware noted above, may be implemented on a single silicon chip (not shown), and the apparatus for injecting errors and testing lock step functionality comprises the associated hardware.

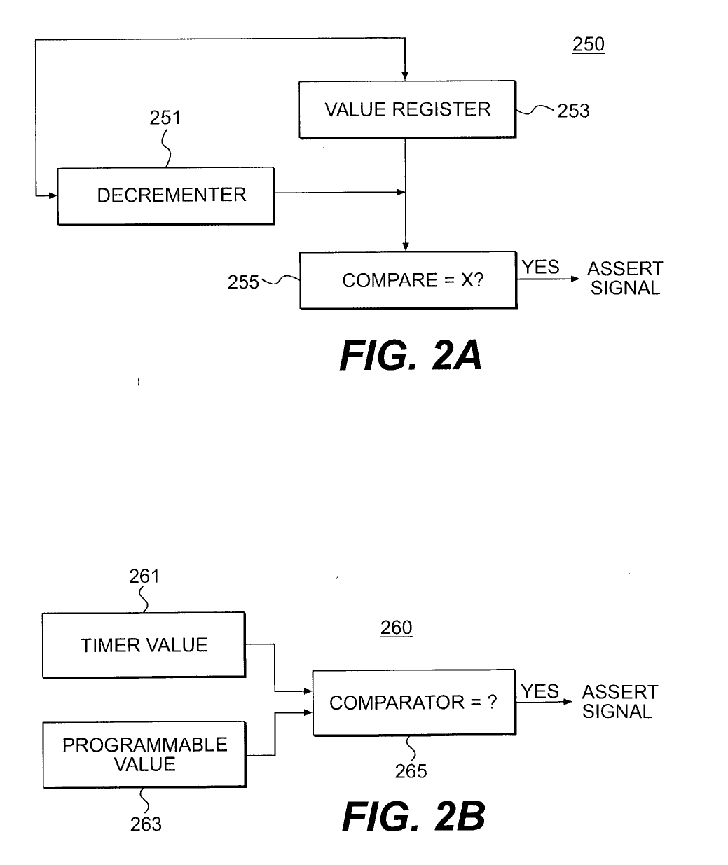

FIGS. 2A-2C illustrate various state machines that may be used in the environment 200 of FIG. 1. FIG. 2A shows a countdown counter 250 that provides a one-time assertion of a test MCA or error test signal. The countdown timer 250 includes a decrementer 251, a value register 253, and a comparator 255. The comparator 255 reads a value from the value register 253 every clock cycle, or at some other defined periodicity. The decrementer 251 decrements the value in the value register 253 by one (or some other amount) every clock cycle. The comparator 255 compares the read value in a particular clock cycle to a set value, such as zero, for example. When the read value reaches the set value, the counter 250 signals its associated logic hardware to assert the test MCA signal.

FIG. 2B shows a timer 260 that also provides a one-time assertion of a test MCA signal. The timer 260 includes a timer value register 261, which counts up by one or some other value every clock cycle, or some other periodicity, and a programmable value register 263, both coupled to a comparator 265. The comparator 265 continually reads values in the registers 261 and 263, and provides a machine check assertion signal when the two values are equal.

FIG. 2C illustrates an alternate timer 270 that provides for assertion of a test MCA signal. The timer 270 includes a timer register 271, a programmable mask register 273, and a programmable value register 275. The registers 271 and 273 are coupled to an AND gate 277. An output of the AND gate 277 is coupled to a comparator 279. The comparator 279 sends a test MCA assertion signal when the AND gate output matches the value of the programmable value register 275.

The various state machines shown in FIGS. 2A-2C, are but examples of devices that can be used to control assertion of test MCA signals.

The state machines associated with the processor cores 210 and 220 may be controlled so that only one of the state machines asserts a signal to the lock step logic block 230. In a situation in which the chips designer desires to test a loss of lock step (or other error), the processor core 210, and its associated test hardware, for example, may be controlled to be the source of the asserted MCA signal. In this situation, the chip designer may desire to test a loss of lock step, and initiate subsequent recovery, based on a detected error in the processor core 210. Thus, only the state machine associated with the processor core 210 is controlled to assert the test MCA signal. Upon assertion of the test MCA signal, the lock step logic block 230 turns off, and the processor core 220 runs in an unprotected mode. Recovery from the loss of lock step then may be initiated from the processor core 220. The chip designer may also desire to assert test MCA signals from both processor cores 210 and 220.

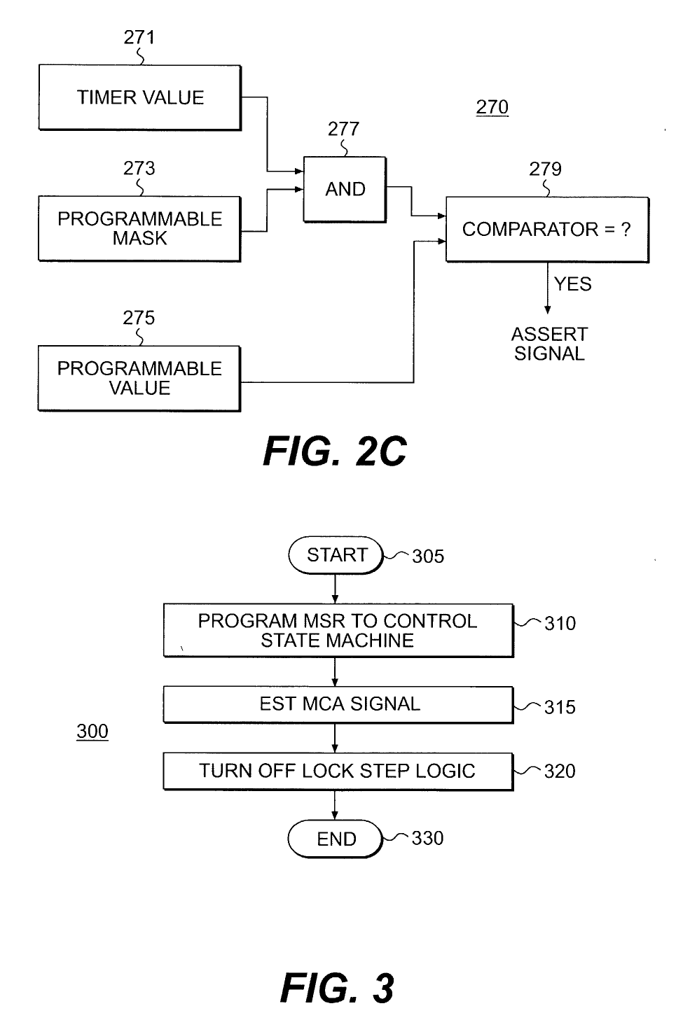

FIG. 3 is a flow chart illustrating a test operation 300 of the apparatus of FIG. 1. The operation 300 begins in block 305. In block 310, the chip designer loads a code sequence to program one or both of the MSRs associated with the core processors 210 and 220. For example, the state machine 212 may be controlled to initiate the test MCA signal. In block 315, the programmed MSR controls the state machine 212 to assert the test MCA signal. In block 320, the test logic receives the asserted test MCA signal from the state machine 212, and turns off, ending lock step operation of the processors 210 and 220. Thereafter, the processors 210 and 220 operate in independent mode until lock step operation is restored. The operation 300 then ends, block 330.

The terms and descriptions used herein are set forth by way of illustration only and are not meant as limitations. Those skilled in the art will recognize that many variations are possible within the spirit and scope of the invention as defined in the following claims, and there equivalents, in which all terms are to be understood in their broadest possible sense unless otherwise indicated.

1. An apparatus for testing lock step functions in a multi-processor environment, comprising:
two or more processors operating in a lock step mode, wherein each of the two or more processors comprise:
processor logic to execute a code sequence, wherein an identical code sequence is executed by the processor logic of each of the two or more processors,
a state machine that asserts a signal based on the occurrence of a programmable event, and
an output to provide the asserted signal; and
a lock step logic block operable to read and compare the output of each of the two or more processors.

2. The apparatus of claim 1, wherein the state machine comprises one of a countdown timer and an array of programmable registers.

3. The apparatus of claim 1, wherein the asserted signal comprises a test machine check.

4. The apparatus of claim 1, wherein the processor-specific resource executes the programmable event to cause the state machine to assert the signal.

5. A method for testing errors in microprocessors, comprising:
programming a processor unique resource to control a state machine based on occurrence of a programmable event;
asserting a test signal upon occurrence of the programmable event;
reading the asserted test signal; and
turning off a lock step logic upon reading the asserted test signal, whereby lock step operation of two or more processors is stopped.

6. The method of claim 5, wherein the state machine comprises one of a countdown timer and an array of programmable registers.

7. The method of claim 5, wherein the asserted signal comprises a test machine check.

8. The method of claim 5, wherein the processor-unique resource executes the programmable event to cause the state machine to assert the signal.
